(19) United States
(12) Patent Application Publication
(10) Pub. No.: US 2022/0032513 A1
(43) Pub. Date: Feb. 3, 2022

(54) PRODUCTION DEVICE FOR COMPOSITE MATERIAL STRUCTURE, COMPOSITE MATERIAL STRUCTURE PRODUCED BY PRODUCTION DEVICE, AND METHOD FOR PRODUCING COMPOSITE MATERIAL STRUCTURE

(71) Applicant: MITSUBISHI HEAVY INDUSTRIES, LTD., Tokyo (JP)

(72) Inventors: Ryota OZAKI, Tokyo (JP); Masahiko SHIMIZU, Tokyo (JP); Shoya MANO, Tokyo (JP); Yasunori WATANABE, Tokyo (JP)

(21) Appl. No.: 17/298,832

(22) PCT Filed: Nov. 14, 2019
(86) PCT No.: PCT/JP2019/044751

§ 371 Date: Jun. 1, 2021

(30) Foreign Application Priority Data
Dec. 6, 2018 (JP) 2018-229023

(51) Int. Cl. B29C 45/14; B29C 45/26; B29C 70/84

(52) U.S. Cl. CPC B29C 45/14065; B29C 2045/14122; B29C 70/84; B29C 45/2606

(57) ABSTRACT

The present invention produces a reliable composite material structure having high rigidity and strength. A production device is for producing a composite material structure which is formed of continuous fiber laminate plates and a resin, and which includes a tabular panel part and a rib part for reinforcing the panel part, the production device being provided with a mold which includes a first mold and a second mold and in which a space is formed. The first mold includes first mold recesses which form space corresponding to the rib part. The second mold includes a second mold recess which forms a space corresponding to the panel part. In the first mold recesses, insert pins for supporting the continuous fiber laminate plates are provided so as to be placed at a predetermined position in the first mold recesses.

### TECHNICAL FIELD

The present invention relates to a production device for a composite material structure, a composite material structure produced by a production device, and a method for producing a composite material structure.

### BACKGROUND ART

An overmolding method is known as one of methods for molding thermoplastic resins. The overmolding method is a method for disposing an insert component in an injection molding mold and injecting a molten resin to obtain an integrally molded product of the insert component and the resin. PTLs 1 and 2 are provided as, for example, documents which disclose a structure produced by using the overmolding method.

PTL 1 discloses a composite obtained by integrally fusing a thermoplastic resin sheet material obtained by inserting the thermoplastic resin sheet material containing a reinforcing fiber to a cavity of a mold and injecting a thermoplastic resin in a molten state to the sheet material from an injection device, and a injection molded product of the thermoplastic resin, and a molding method of the same.

In addition, PTL 2 discloses a composite structure of a metal and a resin obtained by disposing a metallic material constituting a rib portion in a mold for injection molding and injecting and molding a resin material into the mold, and a molding method of the same.

### CITATION LIST

### Patent Literature

[PTL 1] Japanese Patent No. 5738610

[PTL 2] Japanese Patent No. 6049536

### SUMMARY OF INVENTION

### Technical Problem

However, in the composite molded by the molding method disclosed in PTL 1, the insert component is not provided in the rib portion which greatly affects rigidity or strength of the composite, and the rib portion is formed of the injected resin having low values of physical properties such as a modulus of rigidity, and the like. For this reason, the rigidity and strength of the entire composite are lowered, which may cause a problem that the required rigidity and strength cannot be satisfied.

In addition, in the composite structure disclosed in PTL 2, the insert component is provided in the rib portion. However, a method for supporting the metallic material constituting the rib portion is not disclosed, and positioning of the metallic material in the mold is not considered. Therefore, the position of the metallic material is different for each product, quality of the product may vary, and reliability of the product may decrease.

The present invention has been made in view of such circumstances, and an object thereof is to provide a production device for a composite material structure which produces a composite structure having high rigidity and strength and high reliability, and a composite material structure. Another object of the present invention is to provide a composite structure having high rigidity and strength and high reliability.

### Solution to Problem

In order to solve the above problems, the following means are adopted as a production device for a composite material structure, a composite material structure produced by a production device, and a method for producing a composite material structure.

According to a first aspect of the present invention, there is provided a production device for a composite material structure which is formed of an insert component and a resin and includes a plate-like base portion and a rib portion for reinforcing the base portion, the device including: a mold which includes a first mold having a first parting surface and a second mold having a second parting surface opposing the first parting surface and in which a space is formed; and an injection device which injects the resin to the space, in which the first mold includes a first recessed portion which is recessed from the first parting surface and constitutes a space corresponding to the rib portion as a part of the space, the second mold includes a second recessed portion which is recessed from the second parting surface and constitutes a space corresponding to the base portion as a part of the space, and supporting means for supporting the insert component is provided in the first recessed portion so as to place the insert component at a predetermined position in the first recessed portion.

In the above configuration, the supporting means for supporting the insert component is provided in the first recessed portion which constitutes the space corresponding to the rib portion. Accordingly, it is possible to produce a composite material structure in which the insert component is provided in the rib portion, by injecting the resin into the space inside the mold in a state where the insert component is supported in the first recessed portion. As described above, since the insert component can be provided in the rib portion which greatly affects rigidity or strength, it is possible to produce a composite material structure having high rigidity and strength.

In addition, the supporting means can support the insert component so as to place the insert component at a predetermined position in the first recessed portion. Accordingly, it is possible to set the position of the insert component in the rib portion as a predetermined position. Therefore, it is possible to suppress a variation in position of the insert component in the rib portion for each produced composite material structure. As a result, it is possible to suppress a variation in rigidity and strength of the produced composite material structure, and thus it is possible to improve reliability.

In addition, in the production device for a composite material structure according to one aspect of the present invention, the supporting means may include a protrusion portion which protrudes from a surface continuous with the first parting surface and is able to be fit the insert component.

In the above configuration, the supporting means includes the protrusion portion which protrudes from the surface continuous with the first parting surface and is able to be fit the insert component. Accordingly, since the protrusion portion and the insert component fit each other, relative movement of the insert component with respect to the mold can be regulated. Therefore, it is possible to reliably set the position of the insert component in the rib portion as the predetermined position.

In addition, in the production device for a composite material structure according to one aspect of the present invention, the supporting means may have a protrusion capable of supporting the insert component from below.

In the above configuration, the supporting means has a protrusion capable of supporting the insert component from below. Accordingly, by setting a length of the protrusion as a desired length, it is possible to set a position of the insert component in a vertical direction in the rib portion as a desired position.

The desired position of the insert component in the vertical direction in the rib portion is, for example, a central position of the rib portion in the vertical direction.

In addition, in the production device for a composite material structure according to one aspect of the present invention, the supporting means may include a pressing portion capable of pressing the insert component against a surface continuous with the first parting surface.

In the above configuration, the supporting means may include the pressing portion capable of pressing the insert component against a surface continuous with the first parting surface. When the pressing portion presses the insert component, the insert component can be sandwiched between the surface continuous with the first parting surface and the pressing portion. Accordingly, the relative movement of the insert component with respect to the mold can be regulated. Therefore, it is possible to reliably set the position of the insert component in the rib portion as the predetermined position.

In addition, in the production device for a composite material structure according to one aspect of the present invention, the supporting means may include a fitting recessed portion which fits a part of the insert component, and the fitting recessed portion may be formed at a position separated from both of two opposing surfaces which are surfaces continuous with the first parting surface.

In the above configuration, the supporting means includes a fitting recessed portion which fits a part of the insert component. Accordingly, by fitting the fitting recessed portion and a part of the insert component to each other, the relative movement of the insert component with respect to the mold can be regulated. Therefore, it is possible to reliably set the position of the insert component in the rib portion as the predetermined position.

In addition, the fitting recessed portion is formed at a position separated from both of two opposing surfaces which are surfaces continuous with the first parting surface, among side surfaces of the first recessed portion. Accordingly, when the resin flows into the first recessed portion, the resin enters between the side surface of the first recessed portion and the insert component. At this time, since the insert component is positioned to be separated from both of the two opposing surfaces, the resin flows to both sides of the insert component. The resin shrinks when it is cooled, and accordingly, a shearing force acts on the insert component fused with the resin, when the resin is cooled. In the above configuration, the resin flows to both sides of the insert component. Accordingly, the shearing force due to the resin acts on both sides of the insert component, and thus, the shearing force due to the resin is offset. Therefore, it is possible to suppress deformation of the insert component caused by the shearing force due to the resin, compared to a configuration in which the resin flows only to one side of the insert component.

According to a second aspect of the present invention, there is provided a production device for a composite material structure which is formed of an insert component and a resin and includes a plate-like base portion and a rib portion for reinforcing the base portion, the device including: a mold which includes a first mold having a first parting surface and a second mold having a second parting surface opposing the first parting surface and in which a space is formed; and an injection device which injects the resin to the space, in which the first mold includes a first recessed portion which is recessed from the first parting surface and constitutes a space corresponding to the rib portion as a part of the space, the second mold includes a second recessed portion which is recessed from the second parting surface and constitutes a space corresponding to the base portion as a part of the space, the first recessed portion has a loading surface extending in a horizontal direction and capable of loading the insert component, and the injection device injects the resin from an upper side of the loading surface.

According to the above configuration, the resin injected from the injection device presses the insert component against the loading surface. Accordingly, the relative movement of the insert component with respect to the first mold can be regulated. Therefore, it is possible to reliably set the position of the insert component in the rib portion as the predetermined position.

A composite material structure according to one aspect of the present invention is produced by any of the production device for the composite material structure described above.

In the above configuration, since the insert component is provided in the rib portion which greatly affects the rigidity and strength, it is possible to improve the rigidity and strength.

According to one aspect of the present invention, there is provided a method for producing a composite material structure which is formed of an insert component and a resin and includes a plate-like base portion and a rib portion for reinforcing the base portion, the method including: a support step of supporting, in a recessed portion that corresponds to the rib portion and is a part of a space formed in the mold, the insert component so as to place the insert component at a predetermined position in the recessed portion; and an injection step of injecting the resin to the space.

In the above configuration, the method includes the support step of supporting the insert component in the recessed portion corresponding to the rib portion. As a result, it is possible to produce a composite material structure in which the insert component is provided in the rib portion, by injecting the resin into the space inside the mold in a state where the insert component supported in the recessed portion. As described above, since the insert component can be provided in the rib portion which greatly affects rigidity or strength, it is possible to produce a composite material structure having high rigidity and strength.

In addition, the insert component is supported so as to be placed at a predetermined position in the recessed portion. Accordingly, it is possible to set the position of the insert component in the rib portion as a predetermined position. Therefore, it is possible to suppress a variation in position of the insert component in the rib portion for each produced composite material structure, and improve reliability of the produced composite material structure.

### Advantageous Effects of Invention

According to the present invention, it is possible to provide a production device for a composite material structure which produces a composite structure having high rigidity and strength and high reliability, and a composite material structure. In addition, it is possible to provide a composite structure having high rigidity and strength and high reliability.

### BRIEF DESCRIPTION OF DRAWINGS

FIG. 1 is a schematic perspective view showing a composite material structure according to a first embodiment of the present invention.

FIG. 2 is a diagram showing a method for producing a composite material structure according to the first embodiment of the present invention, in which (a) to (e) schematically show vertical cross-sectional views of a production device at each stage of the production method.

FIG. 3 is a diagram showing a method for producing a composite material structure according to a second embodiment of the present invention, in which (a) and (b) schematically show vertical cross-sectional views of a production device at each stage of the production method.

FIG. 4 is a diagram showing a method for producing a composite material structure according to a third embodiment of the present invention, in which (a) and (b) schematically show vertical cross-sectional views of a production device at each stage of the production method.

FIG. 5 is a diagram showing a method for producing a composite material structure according to a fourth embodiment of the present invention, in which (a) and (b) schematically show vertical cross-sectional views of a production device at each stage of the production method.

FIG. 6 is an enlarged view of a main part of FIG. 5(b).

FIG. 7 is a diagram showing a method for producing a composite material structure according to a fifth embodiment of the present invention, in which (a) and (b) schematically show vertical cross-sectional views of a production device at each stage of the production method.

### DESCRIPTION OF EMBODIMENTS

Hereinafter, an embodiment of a production device for a composite material structure, a composite material structure produced by the production device, and a method for producing a composite material structure according to the present invention will be described with reference to the drawings. In addition, UP in the drawings indicates an upper side.

### First Embodiment

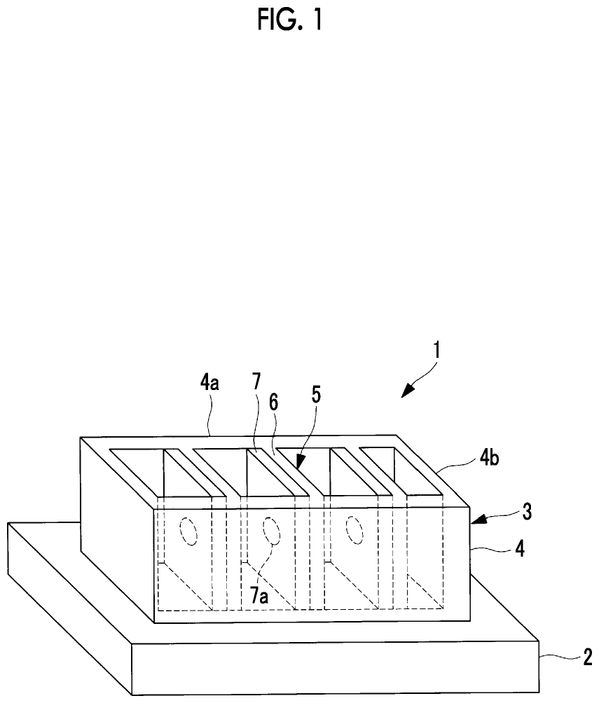

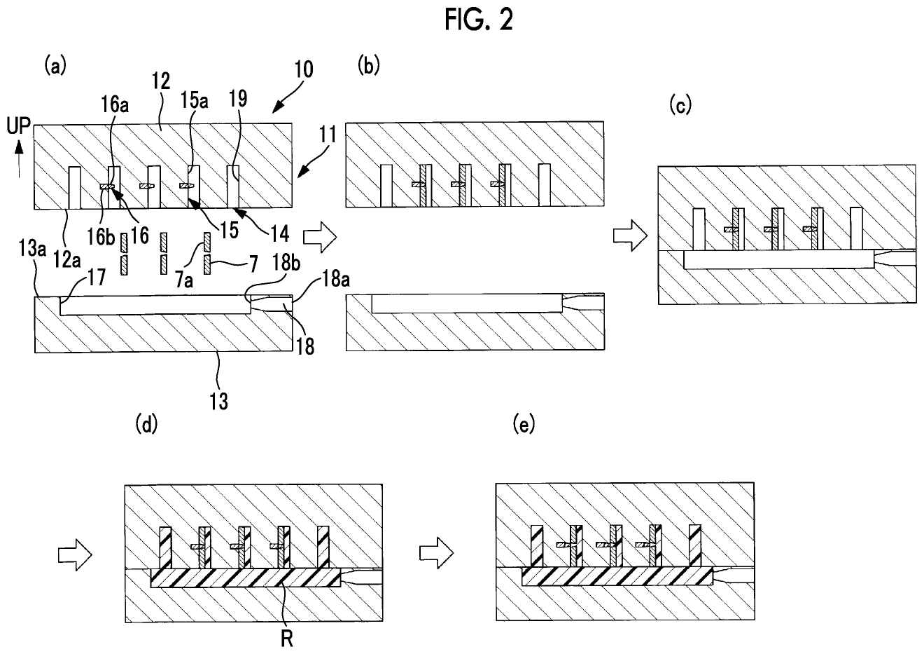

Hereinafter, the first embodiment of the present invention will be described with reference to FIGS. 1 and 2.

A production device for a composite material structure according to the present embodiment (hereinafter, also simply referred to as a “production device”) is, for example, a device for producing a composite material structure 1 used for a panel constituting a door component of an aircraft. As shown in FIG. 1, the composite material structure 1 produced by the production device of the composite material structure integrally includes a panel portion (base portion) 2 formed in a plate shape and a rib portion 3 which is erected from a plate surface of the panel portion 2 to reinforce the panel portion 2.

The panel portion 2 is formed of a thermoplastic resin. The rib portion 3 includes a rectangular frame-shaped frame portion 4 configured with a wall portion which is erected approximately perpendicular to the plate surface of the panel portion 2, and three partition wall portion 5 which partition an internal space of the frame portion 4 at predetermined intervals in a longitudinal direction.

The frame portion 4 is formed of a thermoplastic resin which is the same material as the panel portion 2. The frame portion 4 includes a pair of longitudinal wall portions 4a extending in the longitudinal direction of the frame and a pair of short wall portions 4b extending in a short direction of the frame. The pair of longitudinal wall portions 4a are provided approximately in parallel. The pair of short wall portions 4b are provided approximately in parallel.

The partition wall portion 5 is obtained by integrally fusing a plate-like thermoplastic resin portion 6 formed of a thermoplastic resin which is the same material as the frame portion 4, and a continuous fiber laminate plate (insert component) 7 which is in surface contact with the thermoplastic resin portion 6. That is, the partition wall portion 5 is configured such that the plate-like thermoplastic resin portion 6 and the plate-like continuous fiber laminate plate 7 overlap in a plate thickness direction. The continuous fiber laminate plate 7 is formed in a plate shape by laminating sheet-like continuous fibers, and is impregnated with a thermoplastic resin. A circular through hole 7a penetrating in the plate thickness direction is formed at approximately the center of the continuous fiber laminate plate 7. The through hole 7a is formed in an enlarged diameter shape so that a diameter thereof increases from a surface to be fused with the thermoplastic resin portion 6 (hereinafter, referred to as a “fusion surface”) toward the opposite surface.

Next, a production device 10 for producing the composite material structure 1 will be described with reference to FIG. 2.

The production device 10 is a device for molding a thermoplastic resin by a so-called overmolding method. The overmolding method is a molding method for disposing an insert component (continuous fiber laminate plate 7 in this embodiment) in a space formed inside a mold 11 and injecting a molten resin into the space to obtain a composite material structure which is an integrally molded product of the resin and the insert component.

As shown in FIG. 2, the production device 10 includes the mold 11 in which a space is formed, a driving device (not shown) which moves the mold 11, and an injection device (not shown) which injects the molten resin to the space inside the mold 11. The mold 11 includes a first mold 12 and a second mold 13. The first mold 12 and the second mold 13 have parting surfaces 12a and 13a facing each other, respectively. In the present embodiment, the parting surfaces 12a and 13a of the first mold 12 and the second mold 13 are horizontal surfaces, respectively.

In the first mold 12, a first mold recessed portion (first recessed portion) 14 which is recessed from the first parting surface 12a is formed. The first mold recessed portion 14 is a part of the space formed inside the mold 11 and is formed in a shape corresponding to the rib portion 3 described above. The first mold recessed portion 14 includes a plurality of (three as an example in this embodiment) partition wall portion corresponding recessed portions 15 respectively corresponding to partition wall portions 5, and a frame portion corresponding recessed portion 19 corresponding to the frame portion 4.

The first mold 12 includes an insert pin (supporting means, protrusion portion) 16 which protrudes from a side surface 15a of each partition wall portion corresponding recessed portion 15 (that is, surface continuous with the first parting surface 12a which is a surface forming an angle of 90 degrees with the first parting surface 12a). The insert pin 16 is provided in each partition wall portion corresponding recessed portion 15. The insert pin 16 includes a cylindrical base portion 16a and a tip end portion 16b provided at a tip end of the base portion 16a. The tip end portion 16b is formed in a shape corresponding to the through hole 7a formed in the continuous fiber laminate plate 7. That is, the tip end portion 16b is tapered in diameter toward the tip end.

The insert pin 16 is configured to be movable between a storage position that does not protrude from the side surface 15a (surface on which the insert pin 16 is provided) and a protrusion position that protrudes from the side surface 15a by a predetermined distance by a hydraulic pressure from the hydraulic device (not shown). The predetermined distance is, for example, a distance at which the entire tip end portion 16b protrudes from the side surface 15a, but the base portion 16a does not protrude from the side surface 15a.

In the first mold 13, a second mold recessed portion (second recessed portion) 17 which is recessed from the second parting surface 13a is formed. The second mold recessed portion 17 is a part of the space formed inside the mold 11 and is formed in a shape corresponding to the panel portion 2 described above.

The second mold 13 includes a gate 18 which is an inflow passage for the molten resin supplied from the injection device via a nozzle (not shown). The gate 18 is a through hole that linearly penetrates the second mold 13 in an approximately horizontal direction, and communicates with a space outside the second mold 13 and the second mold recessed portion 17. That is, the gate 18 includes an inlet opening 18a formed on an outer peripheral surface of the second mold 13 and an outlet opening 18b formed on a side surface of the second mold recessed portion 17 (that is, a surface orthogonal to the second parting surface 13a). The outlet opening 18b is formed on the side surface of the second mold recessed portion 17 which faces the side surface 15a on which the insert pin 16 is provided.

The driving device moves the first mold 12 or the second mold 13 so that the first parting surface 12a of the first mold 12 and the second parting surface 13a of the second mold 13 are in surface contact with each other. In a state where the first parting surface 12a of the first mold 12 and the second parting surface 13a of the second mold 13 are in surface contact with each other, the first mold recessed portion 14 and the second mold recessed portion 17 communicate with each other to form one closed space. The example in which the driving device moves any one of the first mold 12 or the second mold 13 has been described, but the mold 11 to be moved by the driving device may be any one of the first mold 12 or the second mold 13.

Next, a method for producing the composite material structure 1 will be described.

First, as shown in FIG. 2(a), in a state where the first parting surface 12a of the first mold 12 and the second parting surface 13a of the second mold 13 are not in contact with each other, all of the insert pins 16 protrude to a predetermined protrusion position. Next, as shown in FIG. 2(b), the continuous fiber laminate plate 7 is introduced into the partition wall portion corresponding recessed portion 15, and the through hole 7a of the continuous fiber laminate plate 7 is fit the tip end portions 16b of all of the insert pins 16. By fitting the tip end portion 16b of the insert pin 16 to the through hole 7a of the continuous fiber laminate plate 7, the continuous fiber laminate plate 7 is supported by the first mold 12 so as to come into surface contact with the side surface 15a of the partition wall portion corresponding recessed portion 15. At that time, the movement of the continuous fiber laminate plate 7 in an out-of-plane direction is regulated by the insert pin 16, and the movement thereof in an in-plane direction is regulated by the side surface 15a of the partition wall portion corresponding recessed portion 15. That is, the continuous fiber laminate plate 7 is supported so that the position in the first mold recessed portion 14 is a predetermined position (support step).

Next, as shown in FIG. 2(c), the driving device is driven to bring the first parting surface 12a of the first mold 12 and the second parting surface 13a of the second mold 13 into surface contact with each other, thereby performing mold closing and mold clamping of the mold 11. Next, as shown in FIG. 2(d), the molten resin is injected and filled in the first mold recessed portion 14 and the second mold recessed portion 17 via the gate 18 (injection step). At that time, the molten resin injected via the gate 18 flows into the closed space in the mold 11 so as to press the continuous fiber laminate plate 7 against the side surface 15a of the partition wall portion corresponding recessed portion 15. This is because that the outlet opening 18b of the gate 18 is formed on the side surface of the second mold recessed portion 17 which faces the side surface 15a on which the insert pin 16 is provided.

Next, the molten resin is cooled until it is solidified. At that time, before the molten resin is completely solidified, as shown in FIG. 2(e), the insert pin 16 is moved to release the fitting between the tip end portion 16b of the insert pin 16 and the through hole 7a of the continuous fiber laminate plate 7. When releasing, the insert pin 16 is moved to the storage position. By releasing the fitting between the tip end portion 16b of the insert pin 16 and the through hole 7a of the continuous fiber laminate plate 7, the molten resin flows into the through hole 7a. The releasing of the fitting between the tip end portion 16b of the insert pin 16 and the through hole 7a of the continuous fiber laminate plate 7 is performed at timing when the molten resin R is solidified to the extent that the molten resin R flows into the through hole 7a and extent that the movement of the continuous fiber laminate plate 7 is regulated by the molten resin R, even if the insert pin 16 is removed from the through hole 7a.

The injected molten resin R melts the surface of the continuous fiber laminate plate 7 and is fused with the continuous fiber laminate plate 7 at the time of the solidification.

When the molten resin R is solidified, the first mold 12 and the second mold 13 are separated from each other by a driving device to open the mold. Then, the composite material structure 1 in which the solidified molten resin R and the continuous fiber laminate plate 7 which is the insert component are integrally fused is taken out from the mold 11.

By doing so, the composite material structure 1 is produced.

According to this embodiment, the following effects are exhibited.

In the present embodiment, the insert pin 16 for supporting the continuous fiber laminate plate 7 is provided in the first mold recessed portion 14 (specifically, the partition wall portion corresponding recessed portion 15) configuring the space corresponding to the rib portion 3. Accordingly, it is possible to produce the composite material structure 1 in which the continuous fiber laminate plate 7 is provided in the rib portion 3, by injecting the resin into the space inside the mold 11 in a state where the continuous fiber laminate plate 7 is supported in the first mold recessed portion 14. As described above, since the continuous fiber laminate plate 7 which is the insert component can be provided in the rib portion 3 which greatly affects rigidity or strength, it is possible to produce the composite material structure 1 having high rigidity and strength. In addition, as the insert component, the continuous fiber laminate plate 7 having a low density and a light weight is used. Therefore, it is possible to reduce the weight of the composite material structure 1, compared to a configuration of using a metal having a high density and a heavy weight as the insert component.

In addition, the insert pin 16 can support the continuous fiber laminate plate 7 so as to place the continuous fiber laminate plate at a predetermined position in the first mold recessed portion 14. Accordingly, it is possible to set the position of the continuous fiber laminate plate 7 in the rib portion 3 as a predetermined position. Therefore, it is possible to suppress a variation in position of the continuous fiber laminate plate 7 in the rib portion 3 for each produced composite material structure 1. As a result, it is possible to suppress a variation in rigidity and strength of the produced composite material structure 1, and thus it is possible to improve reliability.

In addition, the insert pin 16 which protrudes from the side surface 15a of the partition wall portion corresponding recessed portion 15 and fit the through hole 7a of the continuous fiber laminate plate 7 is included. Accordingly, by fitting the insert pin 16 to the continuous fiber laminate plate 7, it is possible to regulate the relative movement of the continuous fiber laminate plate 7 with respect to the first mold 12. Therefore, it is possible to reliably set the position of the insert component in the rib portion 3 as a predetermined position.

In addition, the outlet opening 18b of the gate 18 is formed on the side surface of the second mold recessed portion 17 which faces the side surface 15a on which the insert pin 16 is provided. Accordingly, the molten resin R injected via the gate 18 flows into the closed space in the mold 11 so as to press the continuous fiber laminate plate 7 against the side surface 15a of the partition wall portion corresponding recessed portion 15. Therefore, it is possible to suppress the movement of the continuous fiber laminate plate 7 caused by the inflow of the molten resin R.

In addition, the insert pin 16 is configured to be movable between the storage position that does not protrude from the side surface 15a and the protrusion position that protrudes from the side surface 15a by the predetermined distance, and in a cooling step, the insert pin 16 is moved to release the fitting between the tip end portion 16b of the insert pin 16 and the through hole 7a of the continuous fiber laminate plate 7. Accordingly, since through hole 7a of the continuous fiber laminate plate 7 is also filled with the molten resin R, the through hole 7a does not remain in the composite material structure 1 produced by the production device 10. Therefore, it is possible to improve appearance of the composite material structure 1.

In the present embodiment, the example in which the first mold 12 is positioned above the second mold 13 has been described, but the present invention is not limited thereto. The second mold 13 may be positioned above the first mold 12 (that is, upside down from the example described in the above embodiment). In addition, the first mold 12 and the second mold 13 are disposed so that the surface of the partition wall portion corresponding recessed portion 15 on which the insert pin 16 is provided is a horizontal surface (that is, so that the insert pin 16 protrudes upward), and the continuous fiber laminate plate 7 can be loaded on the surface on which the insert pin 16 is provided.

### Second Embodiment

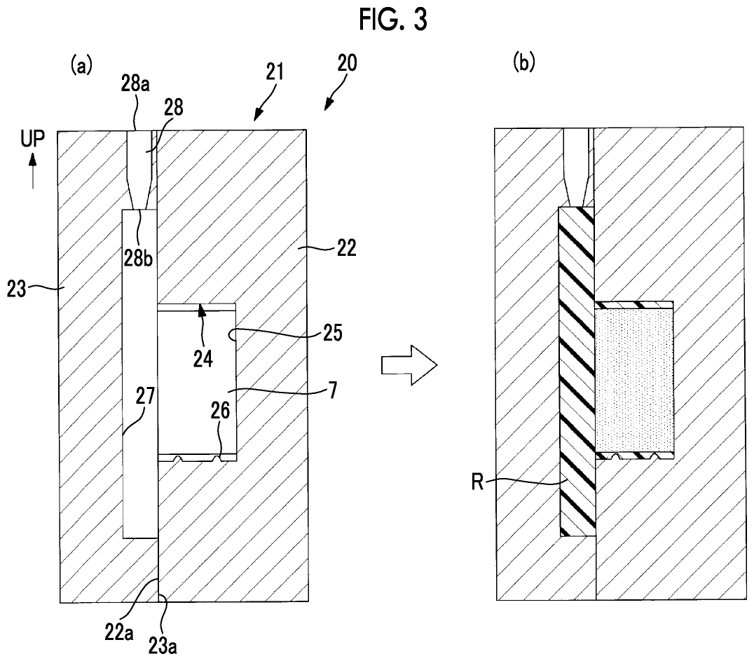

Next, a second embodiment of the present invention will be described with reference to FIG. 3.

In the present embodiment, the structure of the mold 21 is different from that of the first embodiment. A detailed description of the same configuration as in the first embodiment will be omitted.

In addition, in a production device 20 according to the present embodiment, as shown in FIG. 3, a first mold 22 and a second mold 23 are disposed so that a gate 28 penetrates in a vertical direction. That is, in the present embodiment, an inlet opening 28a of the gate 28 is formed on an upper surface of the second mold 23, and parting surfaces 22a and 23a of the first mold 22 and the second mold 23 are vertical surfaces, respectively.

In addition, in the mold 21 according to the present embodiment, the insert pin 16 described in the first embodiment is not provided. Instead of not providing the insert pin 16, a plurality of (two as an example in this embodiment) protrusions 26 protruding upward are provided on a lower surface of the first mold recessed portion 24 (specifically, partition wall portion corresponding recessed portion 25). The protrusion 26 is configured so that the continuous fiber laminate plate 7 can be placed on it. That is, the protrusion 26 is configured so that the continuous fiber laminate plate 7 can be supported from the below. In addition, a length of the protrusion 26 in the vertical direction is set so that the continuous fiber laminate plate 7 is positioned in a central region of the partition wall portion corresponding recessed portion 25 in the vertical direction, in a state where the continuous fiber laminate plate 7 is loaded on the protrusion 26. That is, in a state where the continuous fiber laminate plate 7 is loaded on the protrusion 26, a distance from an upper end of the continuous fiber laminate plate 7 to an upper surface of the partition wall portion corresponding recessed portion 25 and a distance from a lower end of the continuous fiber laminate plate 7 to a lower surface of the wall partition wall portion corresponding recessed portion 25 are approximately the same. The through hole 7a is not formed in the continuous fiber laminate plate 7 of the present embodiment.

Next, a method for producing the composite material structure according to the present embodiment will be described.

First, in a state where the first parting surface 22a of the first mold 22 and the second parting surface 23a of the second mold 23 are not in contact with each other, the continuous fiber laminate plate 7 is introduced into the partition wall portion corresponding recessed portion 25 and loaded on the protrusion 26. By loading it, the continuous fiber laminate plate 7 is positioned in the partition wall portion corresponding recessed portion 25, and the continuous fiber laminate plate 7 is held.

Next, as shown in FIG. 3(a), the driving device is driven to bring the first parting surface 22a of the first mold 22 and the second parting surface 23a of the second mold 23 into surface contact with each other, thereby performing mold closing and mold clamping of the mold 21. Next, as shown in FIG. 3(b), the molten resin R is injected and filled in the first mold recessed portion 24 and the second mold recessed portion 27 via the gate 28. At that time, the molten resin R is also filled between the continuous fiber laminate plate 7 and the lower surface of the partition wall portion corresponding recessed portion 25 and between the continuous fiber laminate plate 7 and the upper surface of the partition wall portion corresponding recessed portion 25. Next, the molten resin R is cooled until it is solidified. When the molten resin R is solidified, the first mold 22 and the second mold 23 are separated from each other by a driving device to open the mold. Then, the composite material structure in which the solidified molten resin R and the continuous fiber laminate plate 7 which is the insert component are integrally fused is taken out from the mold 21.

By doing so, the composite material structure is produced.

The composite material structure according to the present embodiment has a structure in which the longitudinal wall portion 4a of the frame portion 4 is not included, unlike the composite material structure according to the first embodiment. This is because the side surface of the continuous fiber laminate plate 7 is directly supported by the protrusion 26 provided on the first mold 22.

According to this embodiment, the following effects are exhibited.

In this embodiment, the protrusion 26 which supports the continuous fiber laminate plate 7 from below is included. Accordingly, by setting a length of the protrusion 26 in the vertical direction as a desired length, it is possible to set a position of the continuous fiber laminate plate 7 in a vertical direction in the rib portion 3 as a desired position. That is, the resin can be filled in both sides of the vertical direction of the continuous fiber laminate plate 7.

In the present embodiment, the example in which the parting surfaces 22a and 23a of the first mold 22 and the second mold 23 are vertical surfaces, respectively, has been described, but the present embodiment is not limited thereto. For example, the parting surfaces 22a and 23a of the first mold 22 and the second mold 23 are horizontal surfaces, respectively.

In addition, in the present embodiment, the example in which the length of the protrusion 26 in the vertical direction is set to a length so that the continuous fiber laminate plate 7 is positioned in a central region of the partition wall portion corresponding recessed portion 25 in the vertical direction, in a state where the continuous fiber laminate plate 7 is loaded on the protrusion 26 has been described above, but the present embodiment is not limited thereto. When the continuous fiber laminate plate 7 is loaded on the protrusion 26, the lower end of the continuous fiber laminate plate 7 may be separated from the lower surface of the partition wall portion corresponding recessed portion 25. Therefore, for example, the length of the protrusion 26 in the vertical direction may be set so that the upper end of the continuous fiber laminate plate 7 is in contact with the upper surface of the partition wall portion corresponding recessed portion 25, in a state where the continuous fiber laminate plate 7 is loaded on the protrusion 26.

### Third Embodiment

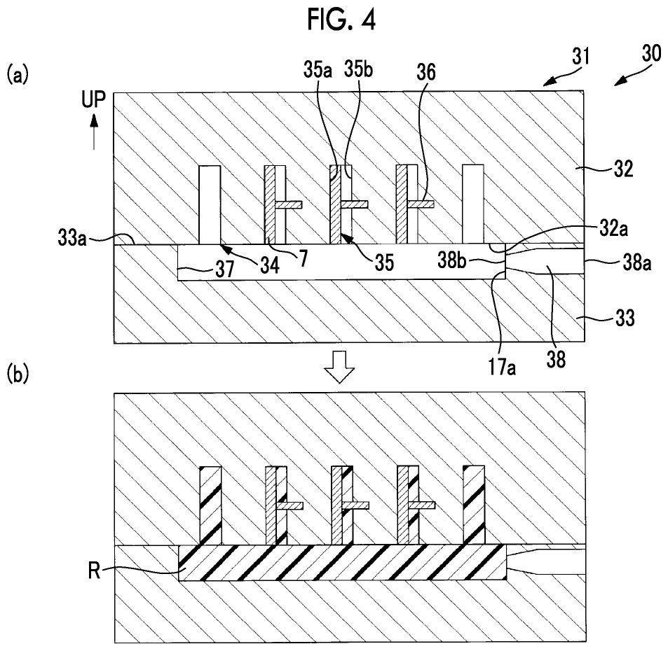

Next, a third embodiment of the present invention will be described with reference to FIG. 4.

In the present embodiment, the structure of a mold 31 is different from that of the first embodiment. A detailed description of the same configuration as in the first embodiment will be omitted.

As shown in FIG. 4, in the mold 31 according to the present embodiment, the insert pin 16 described in the first embodiment is not provided. Instead of not providing the insert pin 16, the production device 30 according to the present embodiment may include a support rod (pressing portion) 36 which protrudes from a side surface 35b opposing a melting surface of the continuous fiber laminate plate 7 (that is, surface continuous with a first parting surface 32a which is a surface forming an angle of 90 degrees with the first parting surface 32a and not in contact with the continuous fiber laminate plate 7) of the side surface of a partition wall portion corresponding recessed portion 35. In addition, in the production device 30 according to the present embodiment, a first mold 32 and a second mold 33 are disposed so that a gate 38 penetrates in the horizontal direction. That is, in the present embodiment, an inlet opening 38a of the gate 38 is formed on a side surface of the second mold 33, and an outlet opening 38b is formed on a side surface of a space formed inside the second mold 33. The through hole 7a is not formed in the continuous fiber laminate plate 7 of the present embodiment.

The support rod 36 is formed in a columnar shape. In addition, the support rod 36 is configured to be movable between a storage position that does not protrude from the side surface 35b (surface on which the support rod 36 is provided) and a protrusion position that protrude from the side surface 35b by a predetermined distance by a hydraulic pressure from the hydraulic device (not shown). The support rod 36 presses the continuous fiber laminate plate 7 by moving to the protrusion position. Since the support rod 36 presses the continuous fiber laminate plate 7, the continuous fiber laminate plate 7 is sandwiched between the support rod 36 and the partition wall portion corresponding recessed portion 35 to regulate the movement of the continuous fiber laminate plate 7.

Next, a method for producing the composite material structure 1 according to the present embodiment will be described.

First, in a state where a parting surface 32a of the first mold 32 and a second parting surface 33a of the second mold 33 are not in contact with each other, the continuous fiber laminate plate 7 is introduced into the partition wall portion corresponding recessed portion 35. At that time, the support rod 36 is positioned at the storage position. Next, since the entire support rod 36 protrudes to the protrusion position to press the continuous fiber laminate plate 7, the continuous fiber laminate plate 7 is sandwiched between the support rod 36 and the partition wall portion corresponding recessed portion 35. Accordingly, the continuous fiber laminate plate 7 is supported.

Next, as shown in FIG. 4(a), the driving device is driven to bring the first parting surface 32a of the first mold 32 and the second parting surface 33a of the second mold 33 into surface contact with each other, thereby performing mold closing and mold clamping of the mold 31. Next, as shown in FIG. 4(b), the molten resin R is injected and filled in the first mold recessed portion 34 and the second mold recessed portion 37 via the gate 18. At that time, the molten resin R injected via the gate 38 flows into the closed space in the mold so as to press the continuous fiber laminate plate 7 against the side surface of the partition wall portion corresponding recessed portion 35. This is because that the outlet opening 18b of the gate 18 is formed on the side surface 17a which faces the side surface 35a against which the continuous fiber laminate plate 7 is pressed, among the side surface of the second mold recessed portion 17.

Next, the molten resin R is cooled until it is solidified. At that time, the support rod 36 is moved to the storage position before the molten resin R is completely solidified. By moving the support rod 36, the molten resin R flows into a region where the support rod 36 was present. The movement of the support rod 36 is performed at timing when the molten resin R is solidified to the extent that the molten resin R flows into the region where the support rod 36 was present and extent that the movement of the continuous fiber laminate plate 7 is regulated by the molten resin R, even if the support rod 36 is moved. By moving the support rod 36, holes due to the support rod 36 are not formed in the composite material structure produced by the production device 30, and accordingly, the beauty of the view can be improved.

When the molten resin R is solidified, the first mold 32 and the second mold 33 are separated from each other by a driving device to open the mold. Then, the composite material structure 1 in which the solidified molten resin R and the continuous fiber laminate plate 7 which is the insert component are integrally fused is taken out from the mold 31.

By doing so, the composite material structure 1 is produced.

According to this embodiment, the following effects are exhibited.

In the present embodiment, the support rod 36 which presses the continuous fiber laminate plate 7 against the side surface 35a of the partition wall portion corresponding recessed portion 35 is included. Since the support rod 36 presses the continuous fiber laminate plate 7, the continuous fiber laminate plate 7 can be sandwiched between the side surface 35a and the support rod 36. Accordingly, the relative movement of the continuous fiber laminate plate 7 with respect to the mold 31 can be regulated. Therefore, it is possible to reliably set the position of the continuous fiber laminate plate 7 in the rib portion 3 as a predetermined position.

In the present embodiment, the example in which the parting surfaces 32a and 33a of the first mold 32 and the second mold 33 are horizontal surfaces, respectively, has been described, but the present embodiment is not limited thereto. For example, the parting surfaces 32a and 33a of the first mold 32 and the second mold 33 are vertical surfaces, respectively.

### Fourth Embodiment

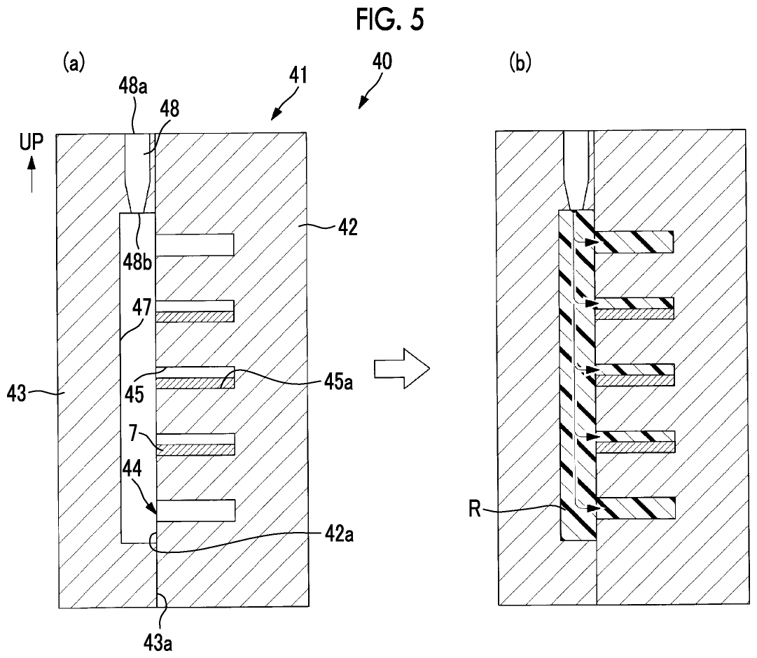

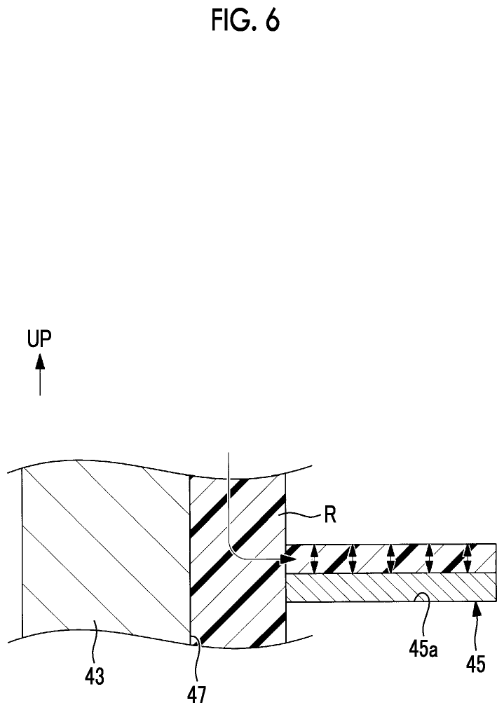

Next, a fourth embodiment of the present invention will be described with reference to FIGS. 5 and 6.

In the present embodiment, the structure of a mold 41 is different from that of the first embodiment. A detailed description of the same configuration as in the first embodiment will be omitted.

As shown in FIG. 5, in the mold 41 according to the present embodiment, the insert pin 16 described in the first embodiment is not provided on a side surface of a partition wall portion corresponding recessed portion 45 of a first mold 42.

In addition, in a production device 40 according to the present embodiment, the first mold 42 and a second mold 43 are disposed so that a gate 48 penetrates in the vertical direction. That is, in the present embodiment, an inlet opening 48a of the gate 48 is formed on an upper surface of the second mold 43, and an outlet opening 48b is formed on a ceiling surface of a closed space formed inside the mold 41. In addition, the parting surfaces 42a and 43a of the first mold 42 and the second mold 43 are vertical surfaces, respectively. The through hole 7a is not formed in the continuous fiber laminate plate 7 of the present embodiment.

Next, a method for producing the composite material structure 1 according to the present embodiment will be described.

First, in a state where the parting surface 42a of the first mold 42 and the second parting surface 43a of the second mold 43 are not in contact with each other, the continuous fiber laminate plate 7 is introduced into the partition wall portion corresponding recessed portion 45 and loaded on a lower surface 45a of the partition wall portion corresponding recessed portion 45.

Next, as shown in FIG. 5(a), the driving device is driven to bring the parting surface 42a of the first mold 42 and the second parting surface 43a of the second mold 43 into surface contact with each other, thereby performing mold closing and mold clamping of the mold 41. Next, as shown in FIG. 5(b), the molten resin R is injected and filled in the first mold recessed portion 44 and the second mold recessed portion 47 via the gate 48. At that time, as shown with an arrow in FIG. 5(b), the injected molten resin R circulates through the second mold recessed portion 47 formed in the second mold 43, and also flows from the second mold recessed portion 47 to each first mold recessed portion (more specifically, the partition wall portion corresponding recessed portion 45). As shown in FIG. 6, the molten resin R flowing into the partition wall portion corresponding recessed portion 45 presses the continuous fiber laminate plate 7 against the lower surface by moving in the vertical direction.

Next, the molten resin R is cooled until it is solidified. When the molten resin R is solidified, the first mold 42 and the second mold 43 are separated from each other by a driving device to open the mold. Then, the composite material structure 1 in which the solidified molten resin R and the continuous fiber laminate plate 7 which is the insert component are integrally fused is taken out from the mold 41.

By doing so, the composite material structure 1 is produced.

According to this embodiment, the following effects are exhibited.

In the present embodiment, the continuous fiber laminate plate 7 is loaded on the lower surface of the partition wall portion corresponding recessed portion 15, and the outlet opening 18b of the gate 18 is formed on the ceiling surface of the closed space formed inside the mold 41. Accordingly, as shown in FIG. 6, the molten resin R flowing into the partition wall portion corresponding recessed portion 15 presses the continuous fiber laminate plate 7 against the lower surface by moving in the vertical direction. Accordingly, the relative movement of the continuous fiber laminate plate 7 with respect to the mold 41 can be regulated. Therefore, it is possible to reliably set the position of the continuous fiber laminate plate 7 in the rib portion 3 as a predetermined position.

### Fifth Embodiment

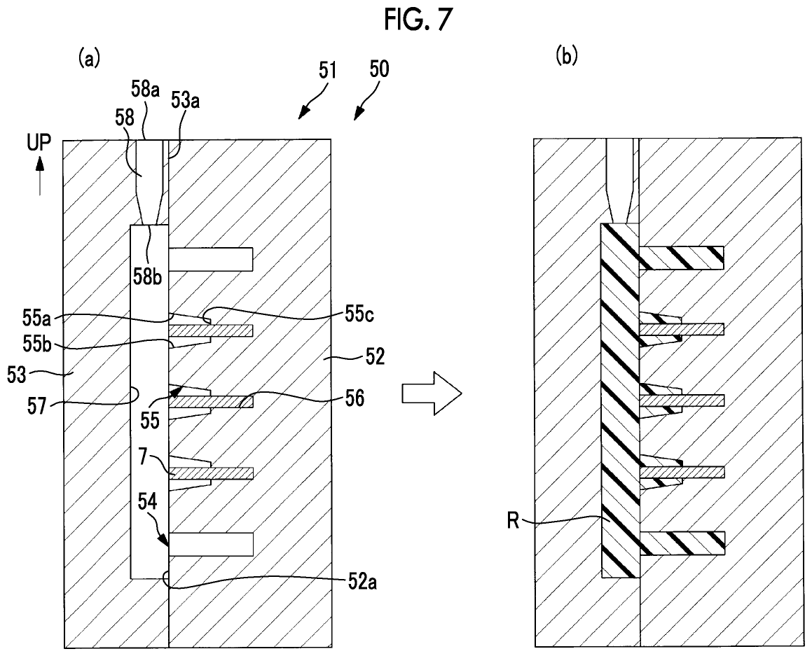

Next, a fifth embodiment of the present invention will be described with reference to FIG. 7.

In the present embodiment, the structure of a mold 51 is different from that of the first embodiment. A detailed description of the same configuration as in the first embodiment will be omitted.

In a mold 51 provided in a production device 50 according to the present embodiment, as shown in FIG. 7, a first mold 52 and a second mold 53 are disposed so that the gate 18 penetrates in the vertical direction. That is, in the present embodiment, an inlet opening 58a of a gate 58 is formed on an upper surface of the second mold 53, and parting surfaces 52a and 53a of the first mold 52 and the second mold 53 are vertical surfaces, respectively.

In addition, in the mold 51 according to the present embodiment, the insert pin 16 described in the first embodiment is not provided. In a partition wall portion corresponding recessed portion 55 according to the present embodiment, a distance from the first parting surface 52a to a bottom surface 55a of the partition wall portion corresponding recessed portion 55 (that is, surface not continuous with the first parting surface 52a) is formed to be shorter than the length of the continuous fiber laminate plate 7. In addition, a fitting recessed portion 56 which is fit the tip end portion of the continuous fiber laminate plate 7 is formed on the bottom surface 55a of the partition wall portion corresponding recessed portion 55. The fitting recessed portion 56 is formed at an intermediate position between an upper surface 55b (surface continuous with the first parting surface 52a) and a lower surface 55c (surface continuous with the first parting surface 52a which is a surface facing the upper surface 55b) of the partition wall portion corresponding recessed portion 55. The through hole 7a is not formed in the continuous fiber laminate plate 7 of the present embodiment.

Next, a method for producing the composite material structure according to the present embodiment will be described.

First, in a state where the first parting surface 52a of the first mold 52 and the second parting surface 53a of the second mold 53 are not in contact with each other, the continuous fiber laminate plate 7 is introduced into the partition wall portion corresponding recessed portion 55. At that time, the continuous fiber laminate plate 7 is inserted and fit the fitting recessed portion 56.

Next, as shown in FIG. 7(a), the driving device is driven to bring the first parting surface 52a of the first mold 52 and the second parting surface 53a of the second mold 53 into surface contact with each other, thereby performing mold closing and mold clamping of the mold 51. Next, as shown in FIG. 7(b), the molten resin R is injected and filled in the first mold recessed portion 54 and the second mold recessed portion 57 via the gate 58. Next, the molten resin R is cooled until it is solidified. When the molten resin R is solidified, the first mold 52 and the second mold 53 are separated from each other by a driving device to open the mold. Then, the composite material structure in which the solidified molten resin R and the continuous fiber laminate plate 7 which is the insert component are integrally fused is taken out from the mold 51.

By doing so, the composite material structure is produced.

According to this embodiment, the following effects are exhibited.

In this embodiment, the fitting recessed portion 56 which is fit a tip end portion of the continuous fiber laminate plate 7 is included. Accordingly, by fitting the fitting recessed portion 56 to the continuous fiber laminate plate 7, it is possible to regulate the relative movement of the continuous fiber laminate plate 7 with respect to the mold 51. Therefore, it is possible to reliably set the position of the continuous fiber laminate plate 7 in the rib portion 3 as a predetermined position.

In addition, the fitting recessed portion 56 is formed at a position separated from both the upper surface 55b and the lower surface 55c of the partition wall portion corresponding recessed portion 55. Accordingly, when the resin flows into the first mold recessed portion 54, the resin enters between the upper surface 55b and the lower surface 55c of the first mold recessed portion 54 and the continuous fiber laminate plate 7. That is, the resin flows into both sides of the continuous fiber laminate plate 7. The resin shrinks when it is cooled, and accordingly, a shearing force acts on the continuous fiber laminate plate 7 fused with the resin, when the resin is cooled. In the present embodiment, the resin flows into both sides of the continuous fiber laminate plate 7. Accordingly, the shearing force due to the resin acts on both sides of the continuous fiber laminate plate 7, and thus, the shearing force due to the resin is offset. Therefore, it is possible to suppress deformation of the continuous fiber laminate plate 7 caused by the shearing force due to the resin, compared to a configuration in which the resin flows only to one side of the continuous fiber laminate plate 7. In addition, the fitting recessed portion 56 is formed at an intermediate position between the upper surface 55b and the lower surface 55c of the partition wall portion corresponding recessed portion 55. Therefore, the shearing forces of the resins on both sides of the continuous fiber laminate plate 7 are approximately the same strength, and thus, it is possible to further suppress deformation of the continuous fiber laminate plate 7.

In the composite material structure according to the present embodiment, the tip end portion of the partition wall portion is formed only on the continuous fiber laminate plate 7, unlike the composite material structure according to the first embodiment.

In the present embodiment, the example in which the parting surfaces 52a and 53a of the first mold 52 and the second mold 53 are vertical surfaces, respectively, has been described, but the present embodiment is not limited thereto. For example, the parting surfaces 52a and 53a of the first mold 52 and the second mold 53 are horizontal surfaces, respectively.

The present invention is not limited to the invention according to the above embodiments, and can be appropriately modified within a range not departing from the gist thereof.

In each of the above embodiments, the example in which the continuous fiber laminate plate 7 is used as the insert component has been described, but the present invention is not limited thereto. For example, a metallic material may be used as the insert component. However, when the continuous fiber laminate plate 7 is used, it is possible to reduce the weight of the composite material structure, compared to the case of using the metallic material.

In addition, the embodiments described above may be combined with each other.

### REFERENCE SIGNS LIST

1: Composite material structure

2: Panel portion

3: rib portion

4: Frame portion

5: Partition wall portion

6: Thermoplastic resin portion

7: Continuous fiber laminate plate

7a: Through hole

10: Production device

11: mold

12: First mold

12a: First parting surface

13: Second mold

13a: Second parting surface

14: First mold recessed portion

15: partition wall portion corresponding recessed portion

15a: Side surface

16: Insert pin

16a: Base portion

16b: Tip end portion

17: Second mold recessed portion

17a: Side surface

18: Gate

18a: Inlet opening

18b: Outlet opening

20: Production device

26: Protrusion

30: Production device

36: Support rod

40: Production device

50: Production device

56: Fitting recessed portion

1. A production device for a composite material structure which is formed of an insert component and a resin and includes a plate-like base portion and a rib portion for reinforcing the base portion, the device comprising:
a mold which includes a first mold having a first parting surface and a second mold having a second parting surface opposing the first parting surface and in which a space is formed; and
an injection device which injects the resin to the space,
wherein the first mold includes a first recessed portion which is recessed from the first parting surface and constitutes a space corresponding to the rib portion as a part of the space,
the second mold includes a second recessed portion which is recessed from the second parting surface and constitutes a space corresponding to the base portion as a part of the space, and
supporting means for supporting the insert component is provided in the first recessed portion so as to place the insert component at a predetermined position in the first recessed portion.

2. The production device for a composite material structure according to claim 1,
wherein the supporting means includes a protrusion portion which protrudes from a surface continuous with the first parting surface and is able to be fit the insert component.

3. The production device for a composite material structure according to claim 1,
wherein the supporting means has a protrusion capable of supporting the insert component from below.

4. The production device for a composite material structure according to claim 1,
wherein the supporting means includes a pressing portion capable of pressing the insert component against a surface continuous with the first parting surface.

5. The production device for a composite material structure according to claim 1,
wherein the supporting means includes a fitting recessed portion which fits a part of the insert component, and
the fitting recessed portion is formed at a position separated from both of two opposing surfaces which are surfaces continuous with the first parting surface.

6. A production device for a composite material structure which is formed of an insert component and a resin and includes a plate-like base portion and a rib portion for reinforcing the base portion, the device comprising:
a mold which includes a first mold having a first parting surface and a second mold having a second parting surface opposing the first parting surface and in which a space is formed; and
an injection device which injects the resin to the space,
wherein the first mold includes a first recessed portion which is recessed from the first parting surface and constitutes a space corresponding to the rib portion as a part of the space,
the second mold includes a second recessed portion which is recessed from the second parting surface and constitutes a space corresponding to the base portion as a part of the space,
the first recessed portion has a loading surface capable of loading the insert component, and
the injection device injects the resin from an upper side of the loading surface.

7. A composite material structure produced by the production device for a composite material structure according to claim 1.

8. A method for producing a composite material structure which is formed of an insert component and a resin and includes a plate-like base portion and a rib portion for reinforcing the base portion, the method comprising:
a support step of supporting, in a recessed portion that corresponds to the rib portion and is a part of a space formed in the mold, supporting the insert component so as to place the insert component at a predetermined position in the recessed portion; and
an injection step of injecting the resin to the space.
